(19) United States
(12) Patent Application Publication
(10) Pub. No.: US 2018/0207758 A1
(43) Pub. Date: Jul. 26, 2018

(54) AUTOMATIC LOCKING/UNLOCKING DEVICE

(71) Applicant: NIO CO., LTD., SHANGHAI (CN)

(72) Inventors: Jianhang CAO, Shanghai (CN); Jan BENGTSSON, Shanghai (CN); Nan LI, Shanghai (CN); Xiaotao TIAN, Shanghai (CN)

(21) Appl. No.: 15/876,665

(22) Filed: Jan. 22, 2018

(30) Foreign Application Priority Data
Jan. 20, 2017 (CN) 201720072119.9

(51) Int. Cl. B23P 19/06; G05D 17/02

(52) U.S. Cl. CPC B23P 19/066; G05D 17/02

(57) ABSTRACT

The present invention relates to the technical field of automation equipment, in particular to an automatic locking/unlocking device. The invention aims to solve the problem of large assembly error and low work efficiency of semi-automatic locking/unlocking methods. The automatic locking/unlocking device of the present invention comprises a control part and a locking/unlocking mechanism, wherein the control part can bring the locking/unlocking mechanism to a mating position corresponding to a target position; and the control part enables a fastener to achieve a target state by controlling the movement of the locking/unlocking mechanism. By means of the control part controlling the movement of the locking/unlocking mechanism so as to achieve the target state of the fastener, the assembly precision of the fastener is improved, and an auto-controlled mounting of the fastener is realized.

### CROSS-REFERENCE TO RELATED APPLICATIONS

This application claims the benefit of China Patent Application No. 201720072119.9 filed Jan. 20, 2017, the entire content of which are incorporated herein by reference.

### TECHNICAL FIELD

The invention relates to the technical field of automation equipment, in particular to an automatic locking/unlocking device.

### BACKGROUND ART

Bolted connections are an important and common connection between parts, and occupy a considerably large proportion in assembly operations, so that the assembly precision thereof has a direct impact on the stability and quality of parts and components. At present, assembly methods of bolts and nuts are classified into manual methods and semi-automatic methods, wherein the semi-automatic methods mainly involve operators cooperating with a semi-automatic locking/unlocking device to complete the assembly of bolts and nuts. For example, after operators place a workpiece to be processed in a designated position in a semi-automatic locking/unlocking device and align the workpiece with a locking/unlocking tool head, the semi-automatic locking/unlocking device operates to lock or unlock the workpiece to be processed.

However, in practical applications, semi-automatic locking/unlocking methods have some limitations. First of all, assembly error is large in semi-automatic assembly methods. Semi-automatic methods require the assistance of operators, where the operators manually conduct the placement of a workpiece to be processed and the alignment of a tool head, and operation error ranges widely with different operators; therefore, such methods are not suitable for situations that require a high assembly precision. Secondly, the work efficiency of semi-automatic methods is low. Since it is impossible for one single operator to complete the assembly of workpieces of a large size or a large area, semi-automatic methods in large equipment fields or highly automated fields (for example, the vehicle manufacturing field or the aerospace field) require a large amount of manual labor to assist with the assembly, which is not only a waste of human resources, but also causes the problem of low efficiency.

Accordingly, there is a need in the art for a new automatic locking/unlocking device to solve the above-mentioned problems.

### SUMMARY OF THE INVENTION

In order to solve the above problems in the prior art, that is, in order to solve the problem of large assembly error and low work efficiency in semi-automatic locking/unlocking methods, the invention provides an automatic locking/unlocking device for enabling fasteners in a target position to achieve a target state, the automatic locking/unlocking device comprising a control part and a locking/unlocking mechanism, wherein the control part can bring the locking/unlocking mechanism to a mating position corresponding to the target position; and the control part enables the fastener to achieve the target state by controlling movement parameters of the locking/unlocking mechanism.

In a preferred technical solution of the above automatic locking/unlocking device, the automatic locking/unlocking device further comprises a recognition mechanism capable of acquiring information at least including information about the target position; and the control part brings the locking/unlocking mechanism to the mating position according to the information about the target position.

In a preferred technical solution of the above automatic locking/unlocking device, the recognition mechanism is an image recognition sensor, and the image recognition sensor, when located at a set position in the automatic locking/unlocking device, has the following features that the image recognition sensor can capture image data at least containing image data of the target position; as the locking/unlocking mechanism moves to reach the mating position, the image recognition sensor can capture image data of the current place where the locking/unlocking mechanism is located; and where the current place is the mating position, the image recognition sensor can capture image data during the mating of the locking/unlocking mechanism and the fastener.

In a preferred technical solution of the above automatic locking/unlocking device, the automatic locking/unlocking device further comprises a guide rail assembly for carrying the locking/unlocking mechanism, and the guide rail assembly allows the locking/unlocking mechanism to reach the mating position.

In a preferred technical solution of the above automatic locking/unlocking device, the guide rail assembly comprises at least one guide rail and at least one slider capable of sliding on the at least one guide rail.

In a preferred technical solution of the above automatic locking/unlocking device, the locking/unlocking mechanism comprises: a locking/unlocking head capable of mating with the fastener and capable of driving the fastener to rotate about a central axis of the locking/unlocking head; and a telescopic rod, one end of the telescopic rod being flexibly connected to the locking/unlocking head, the other end of the telescopic rod being fixedly connected to a slider, among the at least one slider, which can reach the mating position, and in an assembled state, the telescopic rod being capable of driving the locking/unlocking head to move along an axial direction of the telescopic rod through telescopic movement.

In a preferred technical solution of the above automatic locking/unlocking device, the locking/unlocking mechanism further comprises: a pressure sensor for sending pressure signals, generated in the course of the telescopic rod driving the locking/unlocking head to move, to the control part; and a torque sensor for sending torque signals, generated during rotation of the locking/unlocking head, to the control part.

In a preferred technical solution of the above automatic locking/unlocking device, the control part comprises a controller and an electric drive motor set, the controller being used to, based on information received from the recognition mechanism, bring the locking/unlocking mechanism to the mating position according to a set path by controlling one or more electric drive motors in the electric drive motor set, and with the locking/unlocking mechanism mated with the fastener, the controller enabling the fastener to achieve the target state by controlling one or more of the electric drive motors.

In a preferred technical solution of the above automatic locking/unlocking device, the electric drive motor set comprises: at least one displacement drive motor, which can bring the locking/unlocking mechanism to the mating position under the control of the controller by driving the at least one slider to move on the guide rail; a telescopic movement drive motor, which can drive the locking/unlocking head to move towards or away from the fastener under the control of the controller by driving the telescopic movement of the telescopic rod; and a locking/unlocking drive motor, which can drive the locking/unlocking head to rotate about the central axis of the locking/unlocking head under the control of the controller.

In a preferred technical solution of the above automatic locking/unlocking device, the fastener is a bolt or a nut.

It can be understood by those skilled in the art that in a preferred technical solution of the present invention, the automatic locking/unlocking device comprises a control part and a locking/unlocking mechanism, wherein the control part can bring the locking/unlocking mechanism to a mating position corresponding to a target position; and the control part enables a fastener to achieve a target state by controlling the movement of the locking/unlocking mechanism. By using the automatic locking/unlocking device of the present invention to lock or unlock a fastener, not only is the work efficiency of the locking/unlocking process improved, but the assembly precision of the fastener is also improved, and the auto-controlled mounting of the fastener is realized.

### BRIEF DESCRIPTION OF THE DRAWINGS

FIG. 1 is a schematic diagram of an automatic locking/unlocking device of the present invention;

FIG. 2 is a schematic structural diagram of a locking/unlocking mechanism of the automatic locking/unlocking device of the present invention;

FIG. 3 is a schematic diagram of a control part of the automatic locking/unlocking device of the present invention;

FIG. 4A is a schematic diagram of effective contact between the locking/unlocking head of the present invention and a hex bolt; and

FIG. 4B is a schematic diagram of the locking/unlocking head of the present invention and a hex bolt in a mated state.

### DETAILED DESCRIPTION OF EMBODIMENTS

The preferred embodiments of the present invention are described below with reference to the accompanying drawings. It should be understood by those skilled in the art that these embodiments are only for explaining the technical principle of the present invention, and are not intended to limit the protection scope of the present invention. For example, although the locking/unlocking head in the drawings is of a hex socket structure, the structure is not inalterable and can be modified by those skilled in the art to adapt to a specific scenario.

It should be noted that the terms herein that indicate the direction or positional relationship, such as “center”, “upper”, “lower”, “left”, “right”, “vertical”, “horizontal”, “inner” and “outer”, are based on the direction or positional relationship shown in the figures, which is merely for ease of description and not to indicate or imply that the device or element must have a particular orientation and be constructed and operated in a particular orientation, and therefore, should not be construed as limiting the present invention. In addition, the terms “first”, “second” and “third” are used for descriptive purposes only and are not to be construed as indicating or implying relative importance.

In addition, it should also be noted that, in the description of the present invention, the terms “mount”, “engage” and “connect” should be interpreted in a broad sense unless explicitly defined and limited otherwise, which, for example, can mean a fixed connection, a detachable connection or an integral connection; can mean a mechanical connection or an electrical connection; and can mean a direct connection, an indirect connection through an intermediary, or internal communication between two elements. For those skilled in the art, the specific meanings of the above terms in the present invention may be interpreted based on specific situations.

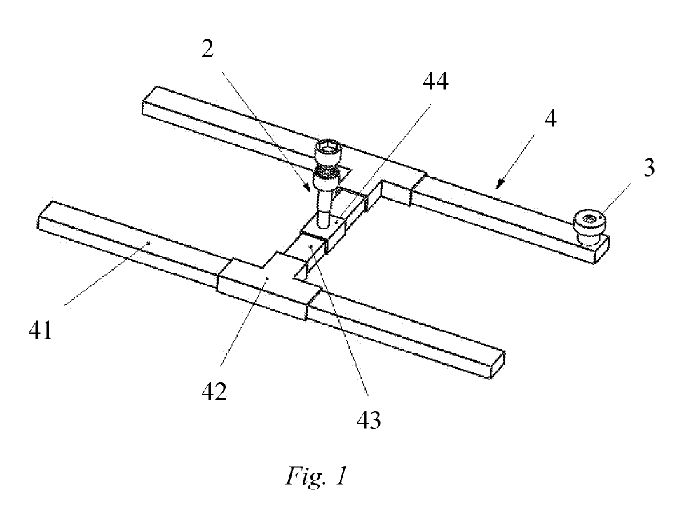

As shown in FIG. 1, the automatic locking/unlocking device of the present invention is mainly used to enable a fastener in a target position to achieve a target state. The automatic locking/unlocking device mainly comprises a control part (not shown) and a locking/unlocking mechanism 2, where the control part can bring the locking/unlocking mechanism 2 to a mating position corresponding to the target position; and the control part enables the fastener to achieve the target state by controlling movement parameters of the locking/unlocking mechanism 2. Preferably, the fastener can be a bolt, such as a hex socket bolt, a hex bolt, a cross head bolt and a special-shaped head bolt. It is conceivable to those skilled in the art that the fastener does not only take one form, and the fastener may also be a mating nut of a bolt, such as a hex socket nut and a hex nut.

The fastener being a bolt is taken as an example, and it should be understood that, in this embodiment, the target position can be a position where the bolt is to be secured, that is, a position where the bolt is to be mounted. The target state ideally may be a state where the bolt is tightened at the target position, that is, the bolt is in a secured state. The mating position can be a projection position directly below the position where the bolt is to be mounted, and the axis of the locking/unlocking mechanism 2 in this position should be collinear with the axis of the bolt.

With continued reference to FIG. 1, the automatic locking/unlocking device further comprises a recognition mechanism. The recognition mechanism can acquire at least the information about the position to be mounted, and the control part can bring the locking/unlocking mechanism 2 to the mating position according to the information about the position to be mounted. Preferably, the recognition mechanism can be an image recognition sensor 3, the number of which is preferably one. The image recognition sensor 3, when located at a set position in the automatic locking/unlocking device (for example, at one end of a track), can be used to capture image data at least containing image data of the position to be mounted, to capture, as the locking/unlocking mechanism 2 moves to reach the mating position, image data of the current place where the locking/unlocking mechanism 2 moves to, and to capture, where the current place is the mating position, image data in the mating process of the locking/unlocking mechanism 2 and the fastener. It should be understood to those skilled in the art that the number of the image recognition sensors 3 is not invariable, on the contrary, the number and the set position of the image recognition sensors 3 can be modified according to the specific environment and precision requirements.

With continued reference to FIG. 1, the automatic locking/unlocking device can further comprise a guide rail assembly 4. The guide rail assembly 4 at least comprises one guide rail and a slider capable of sliding on the at least one guide rail, and the slider sliding on the at least one guide rail can reach a mating position. The locking/unlocking mechanism 2 can be fixed to the slider. According to an initial position and the mating position of the locking/unlocking mechanism 2, the control part moves the slider along the guide rail according to a set path, such that the locking/unlocking mechanism 2 reaches the mating position. Referring to FIG. 1, in a possible embodiment, the guide rail assembly 4 may comprise two transverse guide rails 41 and a longitudinal guide rail 43, wherein the two transverse guide rails 41 are each provided with a transverse slider 42, and the longitudinal guide rail 43 is provided with a longitudinal slider 44. The longitudinal slider 44 can reach the mating position. The locking/unlocking mechanism 2 is fixedly connected to the longitudinal slider 44, and two ends of longitudinal guide rail 43 are respectively connected to the two transverse sliders 42. It is conceivable to those skilled in the art that the configuration of the guide rail assembly 4 is not fixed and can be adjusted according to the specific application environment, as long as it meets the condition of allowing the locking/unlocking mechanism 2 to reach the mating position.

It should be noted that the set path may be any path along which the locking/unlocking mechanism 2 can move from a current place to the mating position, such as a straight path between the current place and the mating position of the locking/unlocking mechanism 2, or a path bypassing obstacles in a straight path.

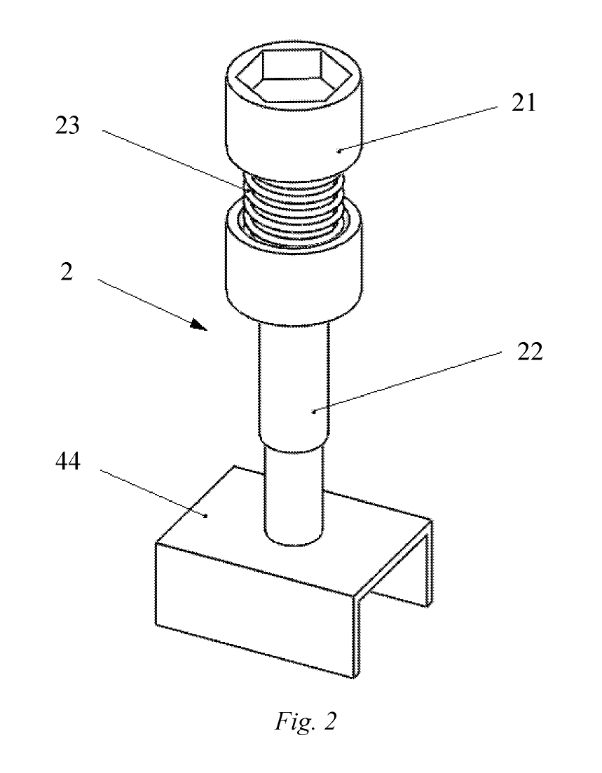

Still taking the situation where the fastener is a bolt as an example, as shown in FIG. 2, the locking/unlocking mechanism 2 mainly comprises a locking/unlocking head 21 and a telescopic rod 22. An end of the locking/unlocking head 21 has an engaging structure capable of mating with a bolt, and the locking/unlocking head 21 can drive the bolt to rotate about the central axis of the locking/unlocking head 21 in a mated state. One end of the telescopic rod 22 is flexibly connected to the locking/unlocking head 21, and the other end is fixedly connected to the longitudinal slider 44. The telescopic rod 22 can drive the locking/unlocking head 21 to move along the axial direction of the telescopic rod 22 through a telescopic movement, which in turn drives the bolt to move along the axial direction of the telescopic rod 22. According to the orientation shown in FIG. 2, the locking/unlocking head 21 is disposed at the top of the telescopic rod 22 and is flexibly connected to the telescopic rod 22. A bottom end of the telescopic rod 22 is fixedly connected to the longitudinal slider 44. Preferably, the flexible connection may be effected by a spring 23.

Further, the locking/unlocking head 21 can be arranged in a replaceable manner, that is, one and the same telescopic rod 22 can be flexibly connected to different types of locking/unlocking heads 21 for application to different kinds of bolts or nuts, so as to improve the applicability of the automatic locking/unlocking device.

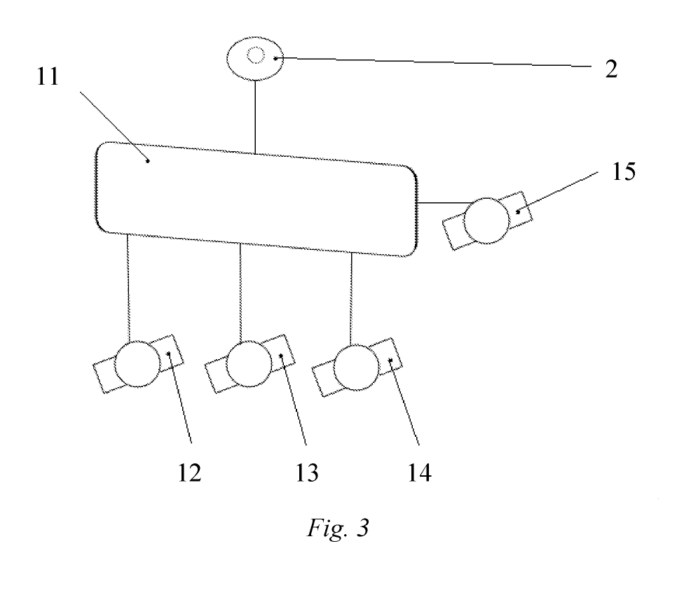

As shown in FIG. 3, the control part mainly comprises a controller 11 and an electric drive motor set including a plurality of electric drive motors. The controller 11 is used to control the plurality of electric drive motors according to the information received from the recognition mechanism, so that the electric drive motors switch to corresponding working states at corresponding timings, for example, to control the start and stop of the electric drive motors. The plurality of electric drive motors can bring the locking/unlocking mechanism 2 to the mating position according to the set path under the control of the controller 11, and with the locking/unlocking mechanism 2 mated with the bolt, can enable the bolt to achieve a secured state.

Preferably, the electric drive motor set may comprise a transverse displacement drive motor 12, a longitudinal displacement drive motor 13, a telescopic movement drive motor 14 and a locking/unlocking drive motor 15. The transverse displacement drive motor 12 and the longitudinal displacement drive motor 13 may respectively drive two transverse sliders 42 and one longitudinal slider 44 under the control of the controller 11 (for example, the controller 11 controls the movement speed and displacement of the sliders) to move on the corresponding guide rail, such that the locking/unlocking mechanism 2 reaches the mating position. The telescopic movement drive motor 14 can drive the telescopic rod 22 to move along the axial direction of the telescopic rod 22 under the control of the controller 11 (for example, the controller 11 controls the movement speed and displacement of the telescopic rod 22), which in turns drives the locking/unlocking head 21 to move towards or away from the bolt. The locking/unlocking drive motor 15 can drive the locking/unlocking head 21 to rotate around the central axis of the locking/unlocking head 21 under the control of the controller 11 (for example, the controller 11 controls the rotating speed and the rotating angle of the locking/unlocking head 21), and enable the bolt to achieve a secured state, i.e. to reach a target state, through the rotation, when the locking/unlocking mechanism 2 is mated with the bolt.

In order to make the control part better detect the secured state of the bolt and control the working states of the plurality of electric drive motors, a pressure sensor (not shown) and a torque sensor (not shown) are provided on the locking/unlocking mechanism 2. The pressure sensor can send pressure signals, generated in the course of the telescopic rod 22 driving the locking/unlocking head 21 to move, to the control part. The torque sensor can send torque signals, generated during rotation of the locking/unlocking head 21, to the control part. For example, the controller 11 may control the start or stop of a corresponding drive motor according to the signal sent by the pressure sensor or the torque sensor. Preferably, the pressure sensor and the torque sensor are respectively mounted under the locking/unlocking head 21 or other positions enabling the sensors to detect the pressure and torque of the locking/unlocking head 21. Alternatively, the pressure sensor and torque sensor can be integrated together.

It should be noted that the image recognition sensor 3, the pressure sensor and the torque sensor each can output analog signals. The controller 11 can receive these analog signals in real time, perform corresponding data processing and calculation based on the analog signals, and further controls the electric drive motors of the electric drive motor set to enable the electric drive motors to be in corresponding working states at corresponding timings. The fastener reaches a secured state by means of the overall movement of the locking/unlocking mechanism 2, the rotation of the locking/unlocking head 21 and/or the telescopic movement of the telescopic rod 22.

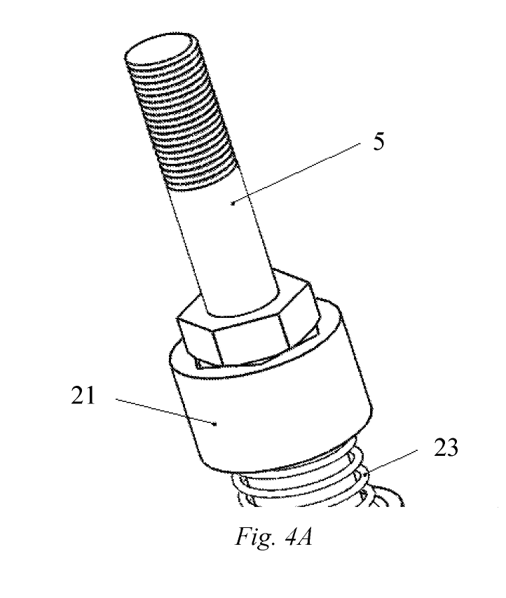

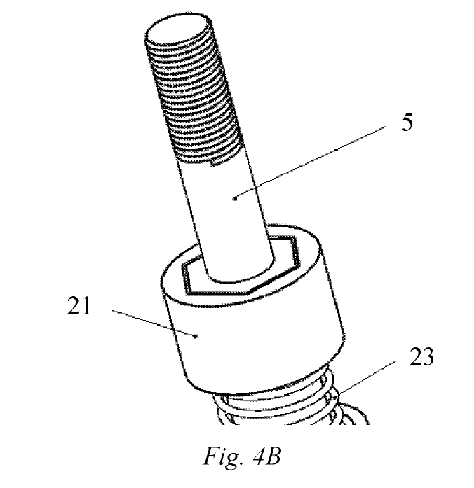

Referring to FIGS. 1, 4A and 4B, the locking process of a hex bolt 5 is taken as an example below to explain the working process of the automatic locking/unlocking mechanism 2 of the present invention.

First, the image recognition sensor 3 acquires image data of the position to be mounted where the hex bolt 5 is located and the current place (for example, the initial position) where the locking/unlocking mechanism 2 is located, and sends the acquired image data to the controller 11. From the image data, the controller 11 extracts the information about the relative positions of the hex bolt 5 and the locking/unlocking head 21, and calculates a path, that is, the aforementioned set path, along which the locking/unlocking mechanism 2 can be approximately moved to the mating position based on the relative position information.

Next, the controller 11 controls the transverse displacement drive motor 12 and/or the longitudinal displacement drive motor 13 to respectively drive the transverse sliders 42 and/or the longitudinal slider 44 to move (for example, move at a high speed), thereby driving the locking/unlocking mechanism 2 to approximately move to the mating position, thus achieving a coarse positioning. Then, the controller 11 further calculates the information about relative positions of the hex bolt 5 and the locking/unlocking mechanism 2 based on the image data captured by the image recognition sensor 3, and calculates a path along which the locking/unlocking mechanism 2 accurately reaches the matching position based on the calculated information about relative positions. Next, the controller controls the transverse displacement drive motor 12 and/or the longitudinal displacement drive motor 13 to respectively drive the transverse sliders 42 and/or the longitudinal slider 44 to move (for example, move at a low speed), thereby driving the locking/unlocking mechanism 2 to accurately move to the mating position, thus achieving an accurate positioning. During the process of performing the accurate positioning by low-speed movement, the controller 11 adjusts the moving path of the locking/unlocking mechanism 2 in real time according to the image data captured by the image recognition sensor 3 in real time, so as to ensure that the locking/unlocking mechanism 2 can finally stop at the mating position where the axis of the locking/unlocking mechanism 2 is collinear with the axis of the bolt. In the process, if the obstacle can not be bypassed effectively, the controller 11 recalculates the moving path.

Then, the controller 11 controls the telescopic movement drive motor 14 so that same works at an extremely low speed, thereby driving the locking/unlocking head 21 to move at an extremely low speed towards the hex bolt 5. When the top of the locking/unlocking head 21 makes contact with the hex bolt 5, the locking/unlocking head is placed under pressure by the hex bolt 5 and thus presses a spring 23, and at this time the pressure sensor outputs the collected pressure signals to the controller 11 in real time. The controller 11 processes the pressure signals to obtain parameters such as the pressure values. When the pressure reaches a preset pressure value, the controller 11 controls the telescopic movement drive motor 14 so that same stops working. At this time, the controller 11 collects the data of the image recognition sensor 3, analyzes and determines whether the locking/unlocking head 21 and the hex bolt 5 are in effective contact or ineffective contact, and where there is effective contact, the first determination is completed. Otherwise, the controller 11 recalculates the movement path of the locking/unlocking mechanism 2 according to the image data of the image recognition sensor 3, adjusts the position of the locking/unlocking mechanism 2 and re-determines whether the contact is effective.

Referring to FIG. 4A, it should be noted that in this embodiment, the effective contact may be where the locking/unlocking head 21 and the hex bolt 5 make contact on the premise that the axis of the locking/unlocking mechanism 2 is collinear with the axis of the hex bolt 5; and the ineffective contact can be where the locking/unlocking head 21 and the hex bolt 5 are not in contact yet, or only a part of the locking/unlocking head 21 makes contact with the hex bolt 5, that is, the axes of the locking/unlocking mechanism 2 and the hex bolt 5 are not collinear where there is ineffective contact.

Referring to FIG. 4B, after the first determination is completed, the controller 11 controls the locking/unlocking drive motor 15 so that same moves in a locking direction of the hex bolt 5 at a relatively low speed, and at this time, the torque sensor outputs the collected torque signals to the controller 11 in real time. The controller 11 processes the torque signals to obtain parameters such as the torque values. When the torque reaches a first preset torque value, the controller 11 controls the locking/unlocking drive motor 15 so that same stops working, the locking/unlocking head 21 and the hex bolt 5 are in a mated state at this time, and the second determination is completed.

Finally, after the second determination for the locking/unlocking head 21 and the hex bolt 5 is completed, the controller 11 controls the locking/unlocking drive motor 15 so that same continues working, such that the locking/unlocking head 21 rotates to drive the hex bolt 5 to rotate synchronously, that is, to perform the locking operation. The torque sensor collects torque signals in real time during the locking operation and sends the torque signals to the controller 11. The controller 11 processes the torque signals to obtain the torque values and other parameters. When the torque value reaches a second preset torque value, the controller 11 controls the locking/unlocking drive motor 15 so that same stops working, and the locking operation is completed. Afterwards, the controller 11 controls the telescopic movement drive motor 14 so that same works in a reverse direction, so as to drive the locking/unlocking head 21 to move away from the hex bolt 5 until the locking/unlocking head is completely separated from the hex bolt 5, and the locking process is completed.

In the above preferred embodiment, the automatic locking/unlocking device comprises a control part, a recognition mechanism, a locking/unlocking mechanism 2 and a guide rail assembly 4. The recognition mechanism can capture the image data of the position to be mounted and a current place where the locking/unlocking mechanism 2 is located, and can transmit the captured data to the control part. The control part, by controlling the corresponding displacement drive motors in the electric drive motor set according to the aforementioned image data, can move the locking/unlocking mechanism 2 to the position to be mounted to mate with the fastener. In addition to this, after the mating, the control part finally brings the fastener to a secured state by controlling the corresponding telescopic movement drive motor 14 and locking/unlocking drive motor 15 in the electric drive motor set. By using the automatic locking/unlocking device of the present invention to lock or unlock a fastener, the work efficiency of the locking/unlocking process is improved significantly. Moreover, in the process of locking/unlocking the fastener, the control part can adjust the movement parameters of corresponding electric drive motors in real time according to the image data, captured by the image recognition sensor, of information about the relative positions of the fastener and the locking/unlocking head 21, so that the assembly precision of the fastener is improved, thereby realizing the auto-controlled mounting of the fastener. In addition, the locking/unlocking head 21 is arranged in a replaceable manner, so that the automatic locking/unlocking mechanism 2 can also be applied to various locking/unlocking working environments. The applicability of the automatic locking/unlocking device to different application scenarios is improved, thus optimizing the use performance of the automatic locking/unlocking device.

Heretofore, the technical solutions of the present invention have been described with reference to the preferred embodiments shown in the accompanying drawings. However, those skilled in the art can readily understand that the protection scope of the present invention is obviously not limited to these specific embodiments. Without departing from the principle of the present invention, a person skilled in the art may make equivalent changes or substitutions on related technical features, and the technical solutions after these changes or substitutions fall into the protection scope of the present invention.

What is claimed is:

1. An automatic locking/unlocking device for enabling a fastener in a target position to achieve a target state, comprising:
a control part, which enable the locking/unlocking mechanism to reach a mating position corresponding to the target position; and
a locking/unlocking mechanism;
wherein the control part enables the fastener to achieve the target state by controlling movement parameters of the locking/unlocking mechanism.

2. The automatic locking/unlocking device according to claim 1, wherein the automatic locking/unlocking device further comprises a recognition mechanism capable of acquiring information at least including information about the target position; and
the control part brings the locking/unlocking mechanism to the mating position according to the information about the target position.

3. The automatic locking/unlocking device according to claim 2, wherein the recognition mechanism is an image recognition sensor, and the image recognition sensor, when located at a set position in the automatic locking/unlocking device, is used to
capture image data at least containing image data of the target position;
capture, during the locking/unlocking mechanism moves to reach the mating position, image data of the current place where the locking/unlocking mechanism is; and
capture, where the current place is at the mating position, image data in the mating of the locking/unlocking mechanism and the fastener.

4. The automatic locking/unlocking device according to claim 3, wherein the automatic locking/unlocking device further comprises a guide rail assembly for carrying the locking/unlocking mechanism, and
the guide rail assembly allows the locking/unlocking mechanism to reach the mating position.

5. The automatic locking/unlocking device according to claim 4, wherein the guide rail assembly comprises at least one guide rail and at least one slider capable of sliding on the at least one guide rail.

6. The automatic locking/unlocking device according to claim 5, wherein the locking/unlocking mechanism comprises:
a locking/unlocking head capable of mating with the fastener and capable of driving the fastener to rotate around a central axis of the locking/unlocking head; and
a telescopic rod, one end of the telescopic rod being flexibly connected to the locking/unlocking head, the other end of the telescopic rod being fixedly connected to a slider, of the at least one slider, which can reach the mating position, and
in an assembled state, the telescopic rod being capable of driving the locking/unlocking head to move along an axial direction of the telescopic rod through a telescopic movement.

7. The automatic locking/unlocking device as claimed in claim 6, wherein the locking/unlocking mechanism further comprises:
a pressure sensor for sending pressure signals, generated in the course of the telescopic rod driving the locking/unlocking head to move, to the control part; and
a torque sensor for sending torque signals, generated during rotation of the locking/unlocking head, to the control part.

8. The automatic locking/unlocking device as claimed in claim 6, wherein the control part comprises a controller and an electric drive motor set,
the controller being used to, based on information received from the recognition mechanism, bring the locking/unlocking mechanism to the mating position according to a set path by controlling one or more electric drive motors of the electric drive motor set, and
with the locking/unlocking mechanism mated with the fastener, the controller enabling the fastener to achieve the target state by controlling one or more of the electric drive motors.

9. The automatic locking/unlocking device according to claim 8, wherein the electric drive motor set comprises:
at least one displacement drive motor, which can bring the locking/unlocking mechanism to the mating position under the control of the controller by driving the at least one slider to move on the guide rail;
a telescopic movement drive motor, which can drive the locking/unlocking head to move toward or away from the fastener under the control of the controller by driving the telescopic movement of the telescopic rod; and
a locking/unlocking drive motor, which can drive the locking/unlocking head to rotate around the central axis of the locking/unlocking head under the control of the controller.

10. The automatic locking/unlocking device according to claim 1, wherein the fastener is a bolt or a nut.

11. The automatic locking/unlocking device according to claim 2, wherein the fastener is a bolt or a nut.

12. The automatic locking/unlocking device according to claim 3, wherein the fastener is a bolt or a nut.

13. The automatic locking/unlocking device according to claim 4, wherein the fastener is a bolt or a nut.

14. The automatic locking/unlocking device according to claim 5, wherein the fastener is a bolt or a nut.

15. The automatic locking/unlocking device according to claim 6, wherein the fastener is a bolt or a nut.

16. The automatic locking/unlocking device according to claim 7, wherein the fastener is a bolt or a nut.

17. The automatic locking/unlocking device according to claim 8, wherein the fastener is a bolt or a nut.

18. The automatic locking/unlocking device according to claim 9, wherein the fastener is a bolt or a nut.
